(19) United States
(12) Patent Application Publication
(10) Pub. No.: US 2013/0191540 A1
(43) Pub. Date: Jul. 25, 2013

(54) COMPUTER READABLE MEDIUM RECORDED WITH INFORMATION PROCESSING PROGRAM, INFORMATION PROCESSING DEVICE, INFORMATION PROCESSING SYSTEM, AND INFORMATION PROCESSING METHOD

(71) Applicant: Hideaki SHIMIZU, Kyoto (JP)

(72) Inventor: Hideaki SHIMIZU, Kyoto (JP)

(73) Assignee: Nintendo Co., Ltd., Kyoto (JP)

(21) Appl. No.: 13/437,216

(22) Filed: Apr. 2, 2012

(30) Foreign Application Priority Data
Jan. 19, 2012 (JP) 2012-009027

(51) Int. Cl. G06F 15/173

(52) U.S. Cl. 709/225

(57) ABSTRACT

An example method includes: transmitting content data to a server that determines whether to permit or deny transmission of storage location information indicating a storage location of the content data; receiving the storage location information from the server; and transmitting the storage location information to another information processing device.

### CROSS-REFERENCE TO RELATED APPLICATIONS

This application is based upon and claims the benefit of priority of the prior Japanese Patent Application No. JP2012-009027, filed on Jan. 19, 2012, the entire contents of which are incorporated herein by reference.

### FIELD

An embodiment relates to a computer-readable medium recorded with an information processing program, an information processing device, an information processing system, and an information processing method.

### BACKGROUND AND SUMMARY

There are services that enable an unspecified number of users to share content data posted to a server on a network. In response to a report filed by a viewer of content data posted to the server, an administrator of the server checks whether the content data is inappropriate or not.

An example of an information processing program according to the embodiment is an information processing program which is executed by a computer of an information processing device and which causes the computer to function as: a first transmitting unit to transmit content data to a server that determines whether to permit or deny transmission of storage location information indicating a storage location of the content data; a receiving unit to receive the storage location information from the server; and a second transmitting unit to transmit the storage location information to another information processing device.

A permission to transmit storage location information that indicates a storage location of content data is a permission to transmit the storage location information to a destination. By transmitting content data to a server that determines whether to permit or deny transmission of storage location information, the information processing device can receive a determination of the server regarding permission or denial of transmission of the storage location information. As a result, reliability of the content data at an access destination can be improved.

The information processing program according to the embodiment further causes the computer of the information processing device to function as requesting unit to request the server for permission to transmit the storage location information. Accordingly, when the information processing device requests the server for permission to transmit the storage location information, the server determines whether to permit or deny transmission of the storage location information.

With the information processing program according to the embodiment, the server determines whether to permit or deny transmission of the storage location information when the content data is received from the information processing device. Accordingly, when the server receives the content data from the information processing device, the server determines whether to permit or deny transmission of the storage location information.

With the information processing program according to the embodiment, the receiving unit receives the storage location information transmitted by the server after the server determines to permit transmission of the storage location information. After the server determines to permit transmission of the storage location information, the information processing device receives the storage location information from the server and transmits the storage location information to another information processing device. After the server determines to permit transmission of the storage location information, the other information processing device accesses the content data. In other words, the determination by the server to permit transmission of the storage location information is made before the other information processing device becomes capable of accessing the content data. As a result, the reliability of the content data at the access destination can be further improved.

With the information processing program according to the embodiment, when the other information processing device accesses the server and verifies that a determination has been made to permit transmission of the storage location information, the storage location information is displayed on a displaying unit included in the other information processing device. The determination by the server to permit transmission of the storage location information has already been made by a point in time when a user of the other information processing device acknowledges the storage location information displayed on the displaying unit and accesses the content data by the other information processing device. Therefore, access to the content data before the determination by the server to permit transmission of the storage location information is made can be suppressed.

With the information processing program according to the embodiment, a second transmitting unit transmits the storage location information to the other information processing device after the server determines to permit transmission of the storage location information. After the server determines to permit transmission of the storage location information, the information processing device transmits the storage location information to the other information processing device. After the server determines to permit transmission of the storage location information, the other information processing device accesses the content data. In other words, the determination by the server to permit transmission of the storage location information is made before the other information processing device becomes capable of accessing the content data. As a result, the reliability of the content data at the access destination can be further improved.

With the information processing program according to the embodiment, when the content data meets predetermined criteria, the server determines to permit transmission of the storage location information. Due to the transmission of the storage location information of the content data meeting predetermined criteria from the server to the information processing device and the transmission of the storage location information of the content data meeting predetermined criteria from the information processing device to another information processing device, the reliability of the content data at the access destination can be further improved.

The information processing program according to the embodiment causes the computer of the information processing device to further function as detecting unit to detecting the other information processing device, and the second transmitting unit transmits the storage location information to the other information processing device that is detected by the detecting unit. Accordingly, even if a user of the information processing device is unaware of the existence of the other information processing device, the information processing device is able to transmit the storage location information to the other information processing device that is detected by the detecting unit.

With the information processing program according to the embodiment, the detecting unit comprises: beacon transmitting unit to transmitting a beacon; and response receiving unit to receiving a response to the transmitted beacon from the other information processing device, and the second transmitting unit transmits the storage location information to the other information processing device that has transmitted the response received by the response receiving unit. Accordingly, even if a user of the information processing device is unaware of the existence of the other information processing device, the information processing device is able to transmit the storage location information to the other information processing device having transmitted the response received by the response receiving unit.

With the information processing program according to the embodiment, the second transmitting unit transmits the storage location information to the other information processing device after a predetermined period of time has lapsed from a predetermined point in time. When the storage location information is transmitted to the other information processing device before the lapse of a predetermined period of time from a predetermined point in time, the other information processing device can access the content data before a determination is made by the server to permit transmission of the storage location information. By having the storage location information transmitted to the other information processing device after a predetermined period of time has lapsed from a predetermined point in time, access to the content data before the determination by the server to permit transmission of the storage location information is made can be suppressed.

With the information processing program according to the embodiment, the storage location information received by the other information processing device is displayed on a displaying unit included in the other information processing device after a predetermined period of time has lapsed from a predetermined point in time. Accordingly, a user of the other information processing device becomes aware of the storage location information after a predetermined period of time has lapsed from a predetermined point in time. Therefore, access to the content data before the determination by the server to permit transmission of the storage location information is made can be suppressed. The predetermined point in time may be a point in time when any one of the first transmitting unit, the requesting unit, and the receiving unit is executed.

With the information processing program according to the embodiment, the number of executions of the second transmitting unit may be limited. By limiting the number of executions of the second transmitting unit, unlimited transmission of the storage location information to the other information processing device can be suppressed.

With the information processing program according to the embodiment, the content data may be UGC (User Generated Contents) data.

With the information processing program according to the embodiment, the storage location information may be a URL (Uniform Resource Locator).

Furthermore, the embodiment may also be comprehended as an information processing device, an information processing system comprising the information processing device, or a method executed by a computer. Moreover, the embodiment may also take the form of the program described above being recorded on a recording medium readable by a device such as a computer, a machine, or the like.

### BRIEF DESCRIPTION OF THE DRAWINGS

FIG. 1 is a diagram illustrating an example of a configuration of an information processing system according to the embodiment;

FIG. 2 is a diagram illustrating an example of a hardware configuration of a server;

FIG. 3 is a diagram illustrating an example of functional blocks of the server;

FIG. 4 is a diagram illustrating an example of a hardware configuration of an information processing device;

FIG. 5A is a diagram illustrating an example of functional blocks of the information processing device;

FIG. 5B is a diagram illustrating an example of functional blocks of the information processing device;

FIG. 6A is a sequence diagram illustrating a first practical example of a system according to the embodiment;

FIG. 6B is a sequence diagram illustrating a second practical example of the system according to the embodiment;

FIG. 7A is a sequence diagram illustrating a third practical example of the system according to the embodiment; and

FIG. 7B is a sequence diagram illustrating a fourth practical example of the system according to the embodiment.

### DETAILED DESCRIPTION OF NON-LIMITING EXAMPLE EMBODIMENTS

Hereinafter, the embodiment will be described with reference to the drawings. Configurations in the embodiment described below are exemplifications, and the embodiment is not limited to the configurations described below.

<System Configuration>

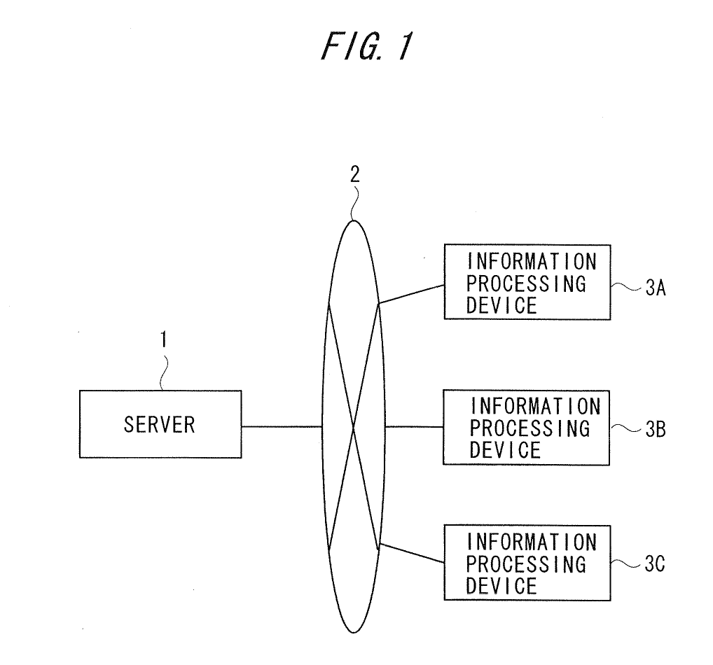

FIG. 1 is a diagram illustrating an example of a configuration of an information processing system according to the embodiment. The information processing system illustrated in FIG. 1 comprises a server 1, and information processing devices 3A, 3B, and 3C which access the server 1 via a network 2. The server 1 and the information processing devices 3A, 3B, and 3C are capable of communicating with each other via the network 2. The information processing devices 3A, 3B, and 3C may be collectively referred to as an information processing device 3. While the information processing devices 3A, 3B, and 3C are illustrated in FIG. 1, the number of the information processing devices 3 is not limited to the number of units illustrated in FIG. 1. The network 2 is a wired or wireless network such as the Internet, a WAN (Wide Area Network), or a LAN (Local Area Network).

The information processing device 3 transmits content data to the server 1. For example, the content data is any of still image data, moving image data, audio data, and text data, or data that combines these types of data. However, the content data may also be data of another type. The content data may be UGC (User Generated Contents) data. The UGC data is content data generated by a user. The UGC data may be generated using the information processing device 3 or using a device other than the information processing device 3.

The server 1 receives the content data from the information processing device 3. The server 1 may store the content data in a memory included in the server 1 or in an external storage device on the network 2.

The server 1 generates storage location information indicating a storage location of the content data. For example, the storage location information is a URL (Uniform Resource Locator). For example, the URL comprises a protocol for accessing the content data existing on the network 2, a name of a server on the network 2 in which the content data exists, and a folder name and a file name in which the content data is stored. Alternatively, the URL may comprise the protocol, the server name, and the folder name.

The information processing device 3 makes a request to the server 1 for permission to transmit the storage location information. A permission to transmit the storage location information is a permission to transmit the storage location information to a destination. At a point in time when the information processing device 3 makes a request to the server 1 for permission to transmit the storage location information, a destination of the storage location information need not be set. However, a destination of the storage location information may be set at a point in time when the information processing device 3 makes a request to the server 1 for permission to transmit the storage location information. For example, in the case of the information processing device 3A, the information processing device 3A may make a request to the server 1 for permission to transmit the storage location information to the information processing device 3B.

The server 1 determines whether to permit or deny transmission of the storage location information before generating the storage location information or after generating the storage location information. When the server 1 determines to permit transmission of the storage location information before generating the storage location information, the server 1 generates the storage location information after determining to permit transmission of the storage location information. When the server 1 determines to deny transmission of the storage location information before generating the storage location information, the server 1 may delete the content data without generating the storage location information. When the server 1 determines to permit transmission of the storage location information after generating the storage location information, the server 1 retains the content data. When the server 1 determines to deny transmission of the storage location information after generating the storage location information, the server 1 may delete the content data.

The server 1 transmits the storage location information to the information processing device 3. In addition, the server 1 may transmit predetermined data with the storage location information to the information processing device 3 or may transmit a file or an e-mail describing the storage location information to the information processing device 3. The information processing device 3 receives the storage location information from the server 1. In addition, the information processing device 3 may receive predetermined data with the storage location information from the server 1 or may receive a file or an e-mail describing the storage location information from the server 1.

The information processing device 3 transmits the storage location information to the other information processing device 3. In addition, the information processing device 3 may transmit predetermined data with the storage location information to the other information processing device 3 or may transmit a file or an e-mail describing the storage location information to the other information processing device 3. The other information processing device 3 will now be described. When the information processing device 3A is a user's own device, the other information processing device 3 refers to one of or both the information processing devices 3B and 3C. While the term “other information processing device 3” is assumed as singular below, such an assumption is not restrictive and the “other information processing device 3” may alternatively be assumed as plural.

The other information processing device 3 receives the storage location information from the information processing device 3. In addition, the other information processing device 3 may receive predetermined data with the storage location information from the information processing device 3 or may receive a file or an e-mail describing the storage location information from the information processing device 3. Based on the storage location information, the other information processing device 3 accesses the content data and acquires (downloads) the content data. For example, when a URL that is an example of the storage location information comprises a protocol, a server name, a folder name, and a file name, the other information processing device 3 accesses on the basis of a URL a file of the content data and acquires (downloads) the file of the content data. For example, when a URL that is an example of the storage location information comprises a protocol, a server name, and a folder name, the other information processing device 3 accesses on the basis of a URL a folder storing the content data and acquires (downloads) a file of the content data.

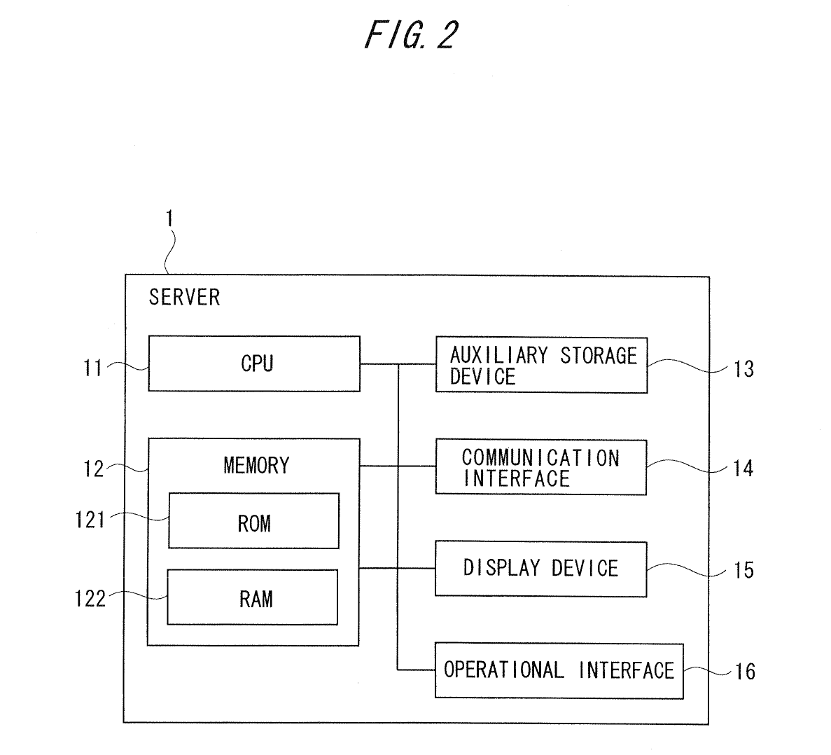

FIG. 2 is a diagram illustrating an example of a hardware configuration of the server 1. The server 1 can be realized using a general purpose computer exemplified by a personal computer (PC) or a dedicated computer exemplified by a server machine. The server 1 comprises a CPU (Central Processing Unit) 11, a memory 12, an auxiliary storage device 13, a communication interface 14, a display device 15, and an operational interface 16. These components are connected to each other via a bus. Components of the server 1 may be added or deleted as appropriate when realizing the server 1.

The CPU 11 executes various processes according to a program stored in the memory 12. The CPU 11 establishes a communication line with the information processing device 3 via the communication interface 14. The memory 12 includes a ROM (Read Only Memory) 121 and a RAM (Random Access Memory) 122. For example, the ROM 121 stores a control program and control data for controlling the server 1. The RAM 122 temporarily stores a program or data and functions as a working area.

The auxiliary storage device 13 controls read and write access to a hard disk (not shown) which stores predetermine data. The communication interface 14 comprises a communication device such as a modem or a terminal adapter and controls communication with the information processing device 3. The display device 15 is, for example, a CRT (Cathode Ray Tube), a liquid crystal display, a plasma display, an organic EL (electroluminescence) display, or the like. The operational interface 16 is, for example, a keyboard, a mouse, or the like and is operated when inputting a predetermined command or predetermine data.

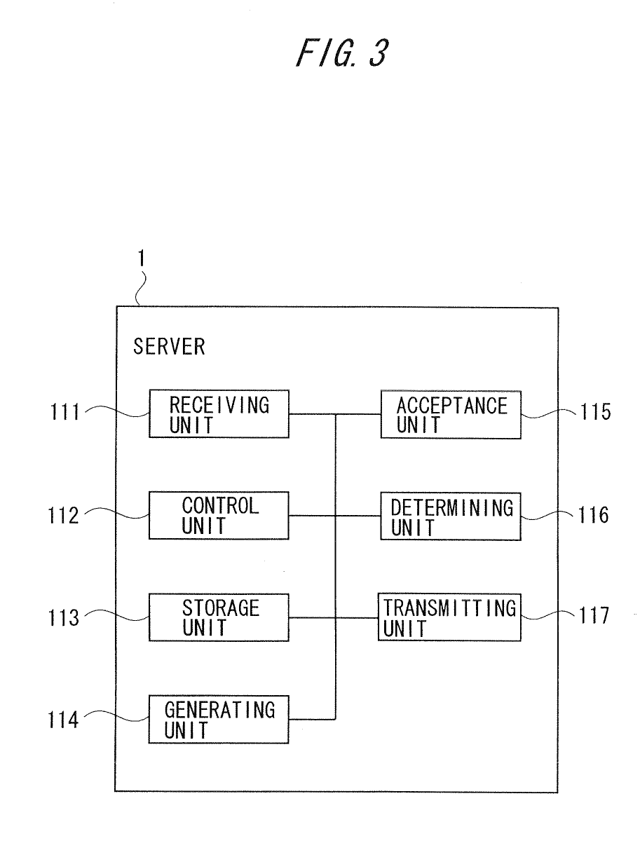

FIG. 3 is a diagram illustrating an example of functional blocks of the server 1. The server 1 comprises a receiving unit 111, a control unit 112, a storage unit 113, a generating unit 114, an acceptance unit 115, a determining unit 116, and a transmitting unit 117. The respective functional units illustrated in FIG. 3 are realized by a computer including the CPU 11, the memory 12, and the like, the communication interface 14, and a program executed on the computer.

The receiving unit 111 receives the content data from the information processing device 3. The control unit 112 stores the content data in the storage unit 113 or in an external storage device on the network 2. The generating unit 114 generates storage location information. The acceptance unit 115 accepts a request for permission to transmit the storage location information from the information processing device 3.

The determining unit 116 determines whether to permit or deny transmission of the storage location information in response to the request for permission to transmit the storage location information. The determination of permission or denial of transmission of the storage location information is made based on whether or not the content data received from the information processing device 3 meets predetermined criteria. When the content data received from the information processing device 3 meets the predetermined criteria, the determining unit 116 determines to permit transmission of the storage location information. When the content data received from the information processing device 3 does not meet the predetermined criteria, the determining unit 116 determines to deny transmission of the storage location information. The determining unit 116 may determine whether or not the content data received from the information processing device 3 meets the predetermined criteria by comparing the content data received from the information processing device 3 with a content data sample. The content data sample may be stored in the storage unit 113 or in an external storage device on the network 2.

The transmitting unit 117 transmits the storage location information to an information processing device 3 that is a source of the content data. For example, if the source of the content data is the information processing device 3A, the transmitting unit 117 transmits the storage location information related to the content data transmitted by the information processing device 3A to the information processing device 3A. When permission to transmit the storage location information has been determined by the determining unit 116, the transmitting unit 117 may transmit information related to the permission to transmit the storage location information to the information processing device 3. When denial to transmit the storage location information has been determined by the determining unit 116, the transmitting unit 117 may transmit information related to the denial to transmit the storage location information to the information processing device 3.

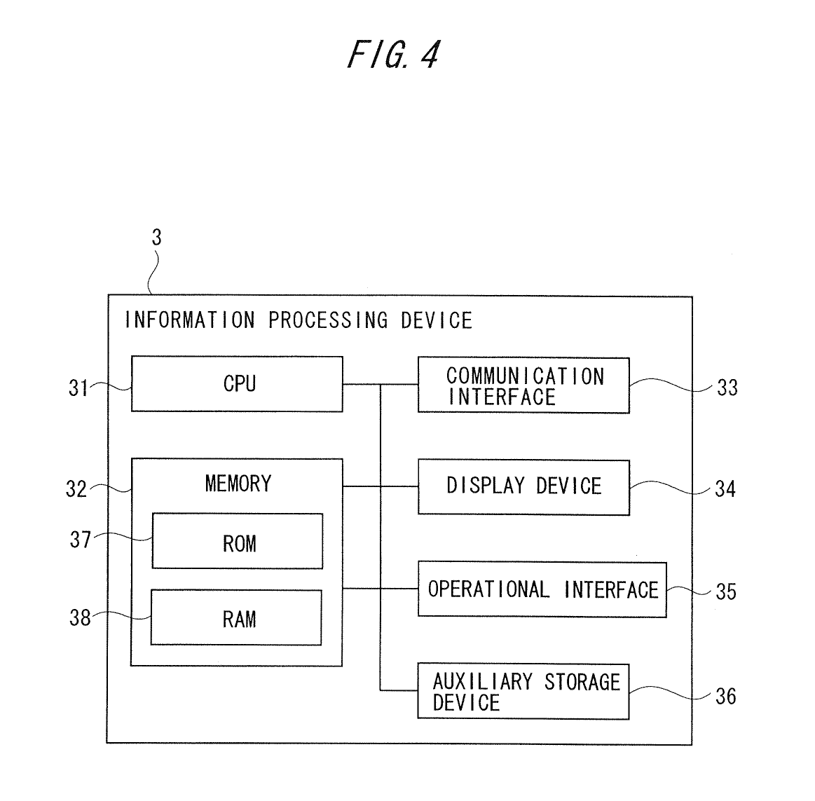

FIG. 4 is a diagram illustrating an example of a hardware configuration of the information processing device 3. The information processing device 3 can be realized using an electronic device such as a PC (Personal Computer), a PDA (Personal Digital Assistant), a smart phone, a tablet terminal, a mobile phone, an electronic book, or a game console. The information processing device 3 comprises a CPU 31, a memory 32, a communication interface 33, a display device 34, and an operational interface 35. The information processing device 3 may further comprise an auxiliary storage device 36. These components are connected to each other via a bus. Components of the information processing device 3 may be added or deleted as appropriate when realizing the information processing device 3.

The CPU 31 executes various processes according to a program stored in the memory 32. The CPU 31 establishes a communication line with the server 1 via the communication interface 33. The memory 32 includes a ROM 37 and a RAM 38. For example, the ROM 37 stores a control program and control data for controlling the information processing device 3. The RAM 38 temporarily stores a program or data and functions as a working area.

The communication interface 33 comprises a communication device such as a modem, a terminal adapter, or a wireless communication module and controls communication with the server 1 or the other information processing device 3. The display device 34 is, for example, a CRT, a liquid crystal display, a plasma display, an organic EL display, or the like. The operational interface 35 is, for example, a keyboard, a mouse, or the like and is operated when inputting a predetermined command or predetermined data. The auxiliary storage device 36 controls read and write access to a hard disk (not shown) which stores predetermined data.

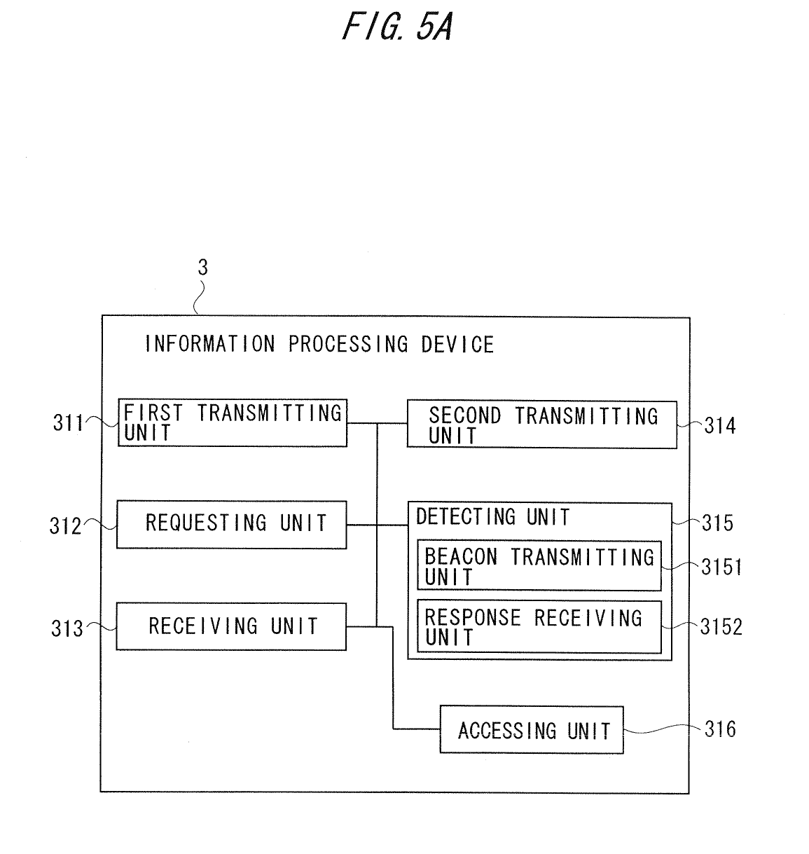

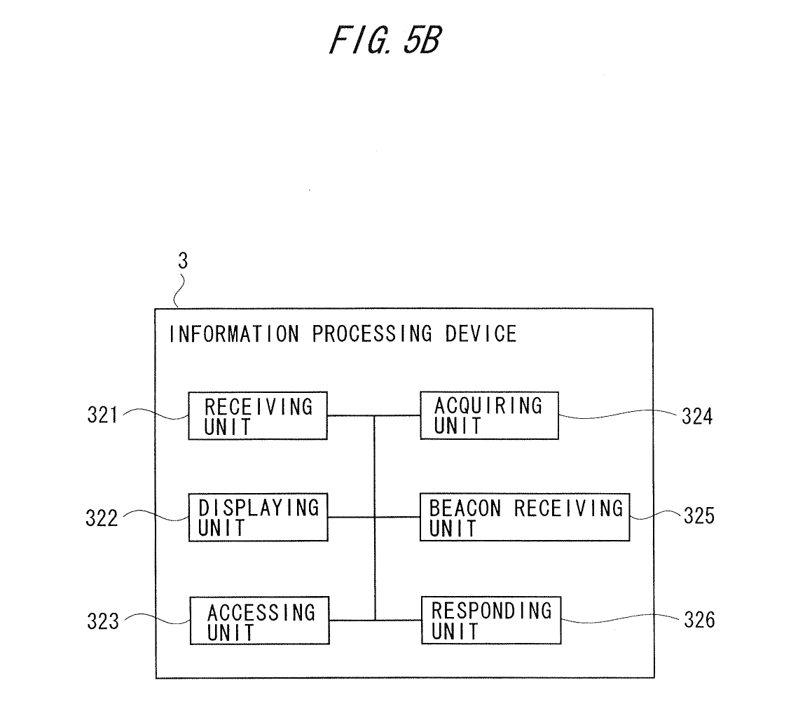

FIG. 5A is a diagram illustrating an example of functional blocks of the information processing device 3. The information processing device 3 comprises a first transmitting unit 311, a requesting unit 312, a receiving unit 313, and a second transmitting unit 314. The information processing device 3 further comprises a detecting unit 315 and an accessing unit 316. The respective functional units illustrated in FIG. 5A are realized by a computer including the CPU 31, the memory 32, and the like, the communication interface 33, and a program executed on the computer.

The first transmitting unit 311 transmits content data to the server 1. The requesting unit 312 makes a request to the server 1 for permission to transmit the storage location information. The receiving unit 313 receives the storage location information from the server 1. The second transmitting unit 314 transmits the storage location information to the other information processing device 3.

The detecting unit 315 detects the other information processing device 3 when the other information processing device 3 is positioned within a predetermined detectable range (for example, when a distance to the other information processing device 3 is 10 m or less) The detecting unit 315 comprises beacon transmitting unit 3151 and a response receiving unit 3152. The beacon transmitting unit 3151 transmits, periodically or at a predetermined point in time, a beacon (a signal) by broadcast to the other information processing device 3 positioned within a communication range. The response receiving unit 3152 receives a response to the beacon transmitted by the beacon transmitting unit 3151 from the other information processing device 3. Upon reception by the response receiving unit 3152 of the response to the beacon from the other information processing device 3, the detecting unit 315 detects the other information processing device 3. When the detecting unit 315 detects the other information processing device 3, the second transmitting unit 314 transmits the storage location information to the detected other information processing device 3. The second transmitting unit 314 may be adapted so that when the detecting unit 315 detects the other information processing device 3, the second transmitting unit 314 may automatically transmit the storage location information to the detected other information processing device 3. In other words, the second transmitting unit 314 may transmit the storage location information to the other information processing device 3 that has been detected even if a user of the information processing device 3 is unaware of the existence of the other information processing device 3. The accessing unit 316 accesses the server 1.

FIG. 5B is a diagram illustrating an example of functional blocks of the information processing device 3. The information processing device 3 comprises a receiving unit 321, a displaying unit 322, an accessing unit 323, an acquiring unit 324, a beacon receiving unit 325, and a responding unit 326. The respective functional units illustrated in FIG. 5B are realized by a computer including the CPU 31, the memory 32, and the like, the communication interface 33, and a program executed on the computer.

The receiving unit 321 receives the storage location information from the other information processing device 3. The receiving unit 321 may automatically receive the storage location information from the other information processing device 3. In other words, the receiving unit 321 may receive the storage location information from the other information processing device 3 even if a user of the information processing device 3 is unaware of the existence of the other information processing device 3. The displaying unit 322 displays the storage location information. The accessing unit 323 accesses the content data based on the storage location information. In addition, the accessing unit 323 accesses the server 1. The acquiring unit 324 acquires (downloads) the content data from the server 1 or from an external storage device on the network 2. The beacon receiving unit 325 receives a beacon transmitted from the other information processing device 3. The responding unit 326 transmits a response to the beacon to the other information processing device 3 that has transmitted the beacon.

The information processing device 3 may selectively comprise the respective functional units illustrated in FIGS. 5A and 5B. The information processing device 3 may comprise the first transmitting unit 311, the requesting unit 312, the receiving unit 313, the second transmitting unit 314, the detecting unit 315, the accessing unit 316, and may further comprise anyone or more of the receiving unit 321, the displaying unit 322, the accessing unit 323, the acquiring unit 324, the beacon receiving unit 325, and the responding unit 326. The information processing device 3 may comprise the receiving unit 321, the displaying unit 322, the accessing unit 323, the acquiring unit 324, the beacon receiving unit 325, the responding unit 326, and may further comprise any one or more of the first transmitting unit 311, the requesting unit 312, the receiving unit 313, the second transmitting unit 314, the detecting unit 315, and the accessing unit 316. The information processing device 3 may further comprise a storage unit. The information processing device 3 may store the storage location information received by the receiving units 313 and 321 in the storage unit. The information processing device 3 may store the content data acquired by the acquiring unit 324 in the storage unit.

### First Practical Example

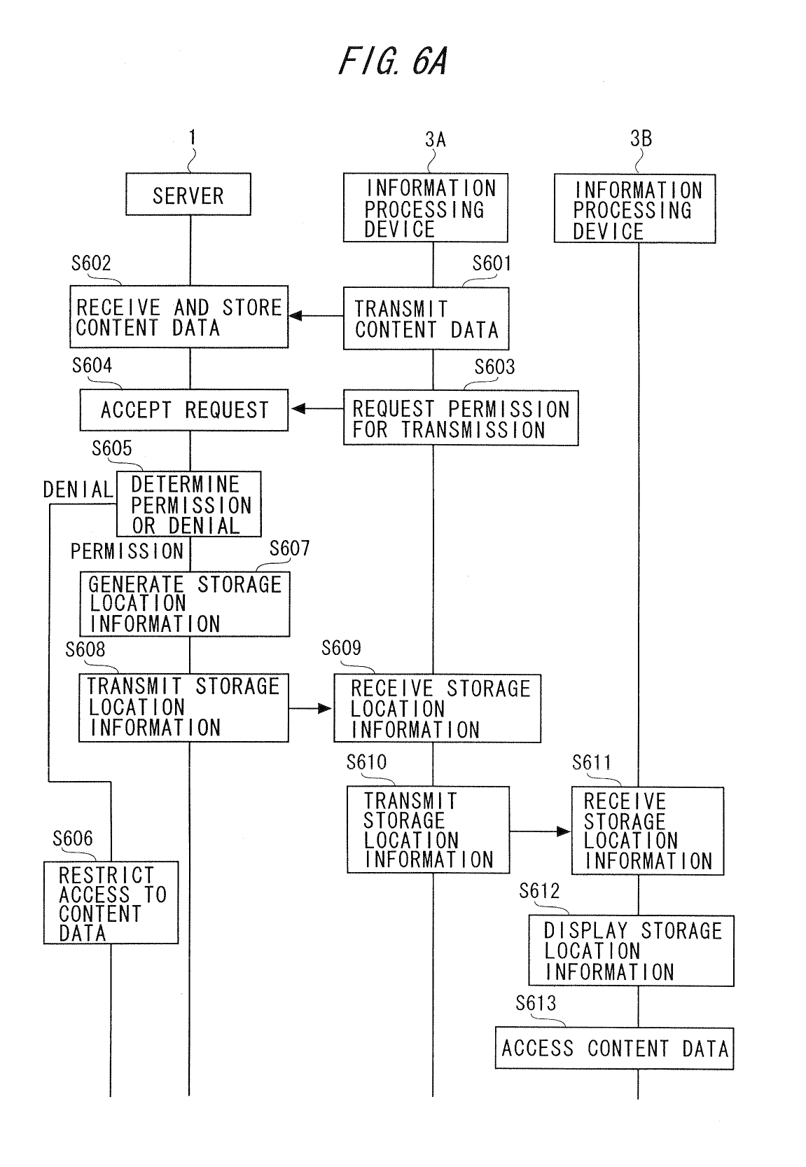

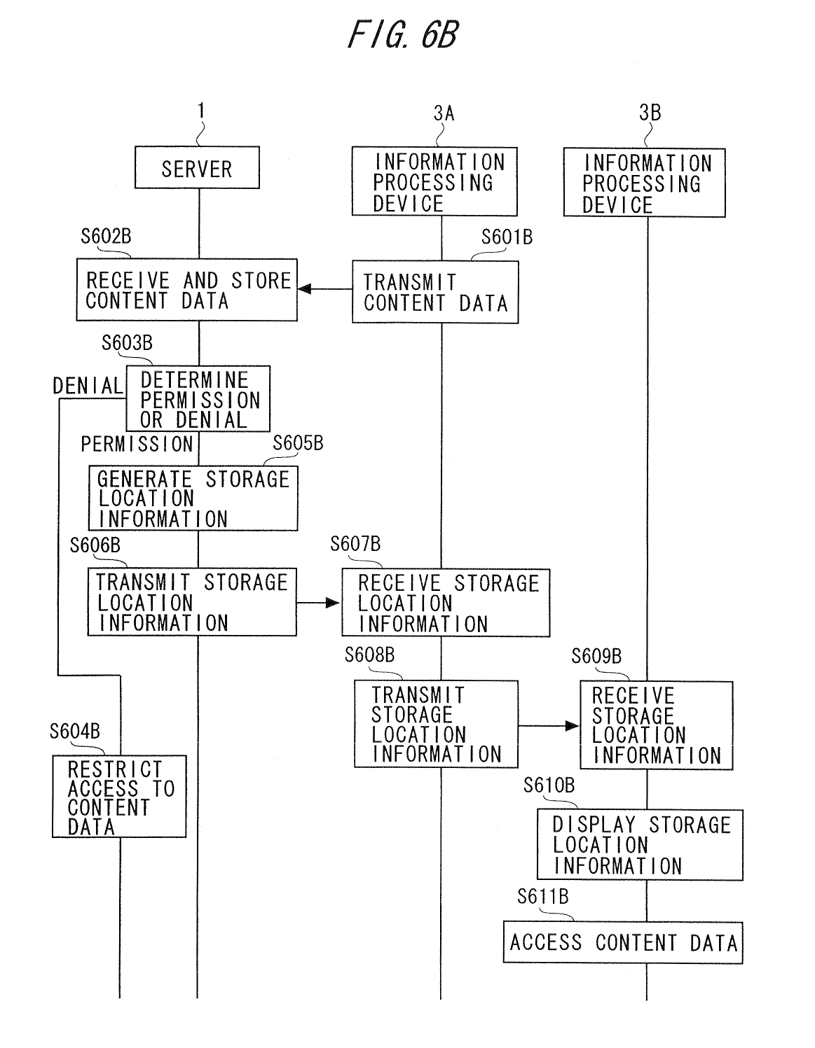

FIG. 6A is a sequence diagram illustrating a first practical example of the system according to the embodiment. The sequence diagram presented in FIG. 6A illustrates an operation example of the system according to the embodiment using the server 1, the information processing device 3A, and the information processing device 3B.

In S601 in FIG. 6A, the first transmitting unit 311 of the information processing device 3A transmits content data to the server 1. In 3602 in FIG. 6A, the receiving unit 111 of the server 1 receives the content data from the information processing device 3A. In S602 in FIG. 6A, the control unit 112 of the server 1 stores the content data in the storage unit 113 of the server 1 or in an external storage device on the network 2.

In S603 in FIG. 6A, the requesting unit 312 of the information processing device 3A makes a request to the server 1 for permission to transmit the storage location information. In S604 in FIG. 6A, the acceptance unit 115 of the server 1 accepts the request for permission to transmit the storage location information from the information processing device 3A.

In S605 in FIG. 6A, the determining unit 116 of the server 1 determines whether to permit or deny transmission of the storage location information in response to the request for permission to transmit the storage location information accepted from the information processing device 3A. When the determining unit 116 of the server 1 determines to deny transmission of the storage location information in response to the request for permission to transmit the storage location information accepted from the information processing device 3A, the process proceeds to S606 in FIG. 6A. On the other hand, when the determining unit 116 of the server 1 determines to permit transmission of the storage location information in response to the request for permission to transmit the storage location information accepted from the information processing device 3A, the process proceeds to S607 in FIG. 6A.

In S606 in FIG. 6A, the control unit 112 of the server 1 sets an access restriction to the content data stored in the storage unit 113 or in an external storage device on the network 2. For example, an access restriction may be set in which the information processing device 3A is able to access the content data but devices other than the information processing device 3A are unable to access the content data. In addition, for example, an access restriction may be set that disables all access to the content data. Furthermore, for example, an access restriction may be set that disables all access to the content data by deleting the content data stored in the storage unit 113 or in an external storage device on the network 2. In S606 in FIG. 6A, the transmitting unit 117 of the server 1 may transmit information regarding the denial of transmission of the storage location information to the information processing device 3A. By having the receiving unit 313 of the information processing device 3A receive information regarding the denial of transmission of the storage location information from the server 1, a user of the information processing device 3A can acknowledge that the content data transmitted to the server 1 does not meet predetermined criteria.

In S607 in FIG. 6A, the generating unit 114 of the server 1 generates the storage location information indicating a storage location of the content data received from the information processing device 3A. In S608 in FIG. 6A, the transmitting unit 117 of the server 1 transmits the storage location information to the information processing device 3A. In this case, the transmitting unit 117 of the server 1 may transmit predetermined data with the storage location information to the information processing device 3A or may transmit a file or an e-mail describing the storage location information to the information processing device 3A. In S609 in FIG. 6A, the receiving unit 313 of the information processing device 3A receives the storage location information from the server 1. In this case, the receiving unit 313 of the information processing device 3A may receive predetermined data with the storage location information from the server 1 or may receive a file or an e-mail describing the storage location information from the server 1.

In S610 in FIG. 6A, the second transmitting unit 314 of the information processing device 3A transmits the storage location information to the information processing device 3B. In this case, predetermined data may be transmitted with the storage location information to the information processing device 3B or a file or an e-mail describing the storage location information may be transmitted to the information processing device 3B. While the sequence diagram presented in FIG. 6A illustrates an example in which the second transmitting unit 314 of the information processing device 3A transmits the storage location information to the information processing device 3B, the embodiment is not limited thereto and the second transmitting unit 314 of the information processing device 3A may alternatively transmit the storage location information to the information processing device 3C. A limit may be set on the number of transmissions of the storage location information. For example, when the number of transmissions of the storage location information is set to one, once the second transmitting unit 314 of the information processing device 3A transmits the storage location information to the information processing device 3B, the second transmitting unit 314 of the information processing device 3A is no longer able to transmit the storage location information to the information processing device 3C. In 5611 in FIG. 6A, the receiving unit 321 of the information processing device 3B receives the storage location information from the information processing device 3A. In this case, the receiving unit 321 of the information processing device 3B may receive predetermined data with the storage location information from the information processing device 3A or may receive a file or an e-mail describing the storage location information from the information processing device 3A.

In 5612 in FIG. 6A, the displaying unit 322 of the information processing device 3B displays the storage location information. In 5613 in FIG. 6A, when a user of the information processing device 3B desires to access the content data, the accessing unit 323 of the information processing device 3B accesses the content data based on the storage location information. In this case, the accessing unit 323 of the information processing device 3B may access the content data according to an instruction or an operation by the user.

### Second Practical Example

FIG. 6B is a sequence diagram illustrating a second practical example of the system according to the embodiment. The sequence diagram presented in FIG. 6B illustrates an operation example of the system according to the embodiment using the server 1, the information processing device 3A, and the information processing device 3B.

In S601B in FIG. 6B, the first transmitting unit 311 of the information processing device 3A transmits content data to the server 1. In S602B in FIG. 6B, the receiving unit 111 of the server 1 receives the content data from the information processing device 3A. In S602B in FIG. 6B, the control unit 112 of the server 1 stores the content data in the storage unit 113 of the server 1 or in an external storage device on the network 2.

In S603B in FIG. 6B, the determining unit 116 of the server 1 determines whether to permit or deny transmission of the storage location information regarding the content data received from the information processing device 3A. When the determining unit 116 of the server 1 determines to deny transmission of the storage location information regarding the content data received from the information processing device 3A, the process proceeds to S604B in FIG. 6B. On the other hand, when the determining unit 116 of the server 1 determines to permit transmission of the storage location information regarding the content data received from the information processing device 3A, the process proceeds to S605B in FIG. 6B.

Since processes of S604B to S611B illustrated in the sequence diagram presented in FIG. 6B are similar to the processes of S606 to S613 illustrated in the sequence diagram presented in FIG. 6A, a description of the processes of S604B to S611B illustrated in the sequence diagram presented in FIG. 6B will be omitted.

According to the first and second practical examples, by having the receiving unit 321 of the information processing device 3B receive the storage location information from the information processing device 3A, the accessing unit 323 of the information processing device 3B can access the content data based on the storage location information and the acquiring unit 324 of the information processing device 3B can acquire (download) the content data from the server 1. Therefore, the information processing device 3B can acquire the content data while suppressing an amount of communication between the information processing device 3A and the information processing device 3B.

According to the first practical example, by having the requesting unit 312 of the information processing device 3A make a request to the server 1 for permission to transmit the storage location information, a determination of the server 1 regarding permission or denial of transmission of the storage location information can be received and reliability of the content data at an access destination can be improved.

According to the second practical example, by having the first transmitting unit 311 of the information processing device 3A transmit the content data to the server 1, a determination of the server 1 regarding permission or denial of transmission of the storage location information can be received and reliability of the content data at the access destination can be improved.

In the first and second practical examples, when the determining unit 116 of the server 1 determines to permit transmission of the storage location information, the transmitting unit 117 of the server 1 transmits the storage location information to the information processing device 3A. After a determination to permit transmission of the storage location information is made by the determining unit 116 of the server 1, the receiving unit 313 of the information processing device 3A receives the storage location information from the server 1 and the second transmitting unit 314 of the information processing device 3A transmits the storage location information to the information processing device 3B. Therefore, after the determination to permit transmission of the storage location information is made by the determining unit 116 of the server 1, the receiving unit 321 of the information processing device 3B receives the storage location information from the information processing device 3A and the accessing unit 323 of the information processing device 3B accesses the content data based on the storage location information. In other words, the determination by the determining unit 116 of the server 1 to permit transmission of the storage location information is made before the accessing unit 323 of the information processing device 3B becomes capable of accessing the content data based on the storage location information. As a result, the reliability of the content data at the access destination can be further improved.

According to the first and second practical examples, a determination of whether the content data meets predetermined criteria is made by the determining unit 116 of the server 1. Therefore, the accessing unit 323 of the information processing device 3B can access the content data meeting the predetermined criteria and the acquiring unit 324 of the information processing device 3B can acquire (download) the content data meeting the predetermined criteria from the server 1.

### Third Practical Example

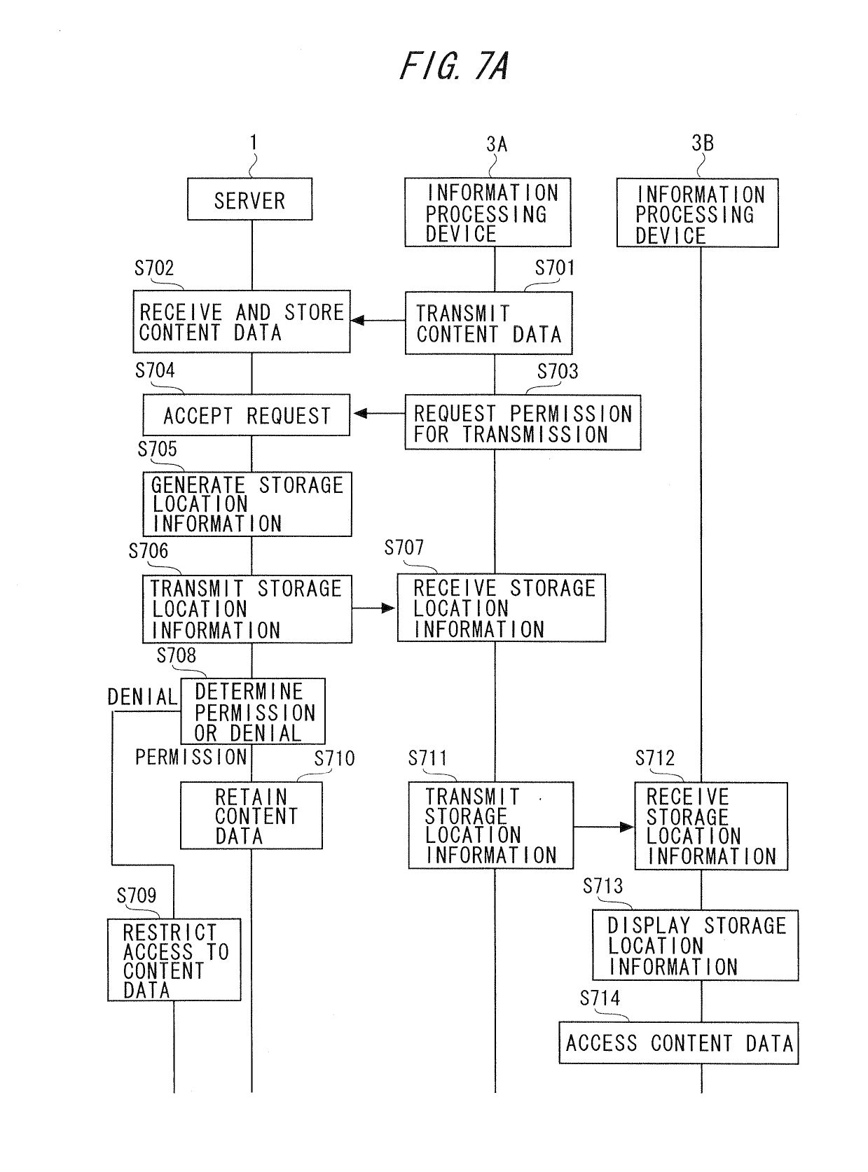

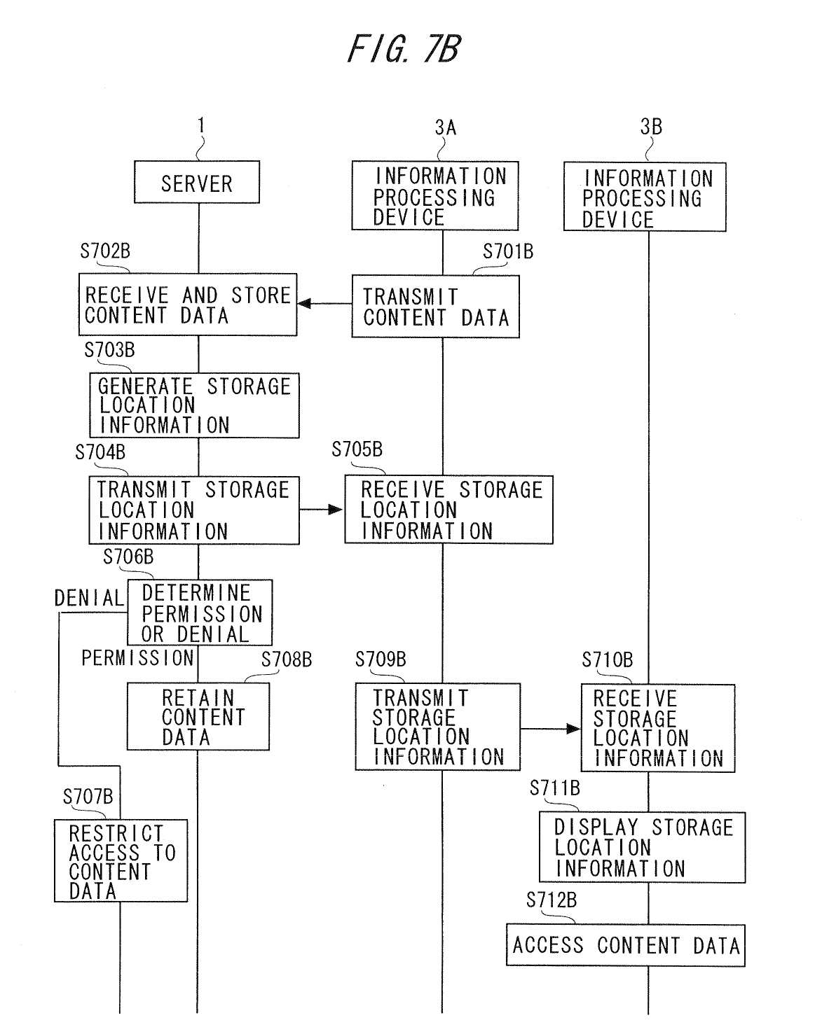

FIG. 7A is a sequence diagram illustrating a third practical example of the system according to the embodiment. The sequence diagram presented in FIG. 7A illustrates an operation example of the system according to the embodiment using the server 1, the information processing device 3A, and the information processing device 3B.

Since processes of S701 to S704 illustrated in the sequence diagram presented in FIG. 7A are similar to the processes of S601 to S604 illustrated in the sequence diagram presented in FIG. 6A, a description of the processes of S701 to S704 illustrated in the sequence diagram presented in FIG. 7A will be omitted. Therefore, processes of S705 and thereafter illustrated in the sequence diagram presented in FIG. 7A will be described below.

In S705 in FIG. 7A, the generating unit 114 of the server 1 generates the storage location information indicating a storage location of the content data received from the information processing device 3A. In S706 in FIG. 7A, the transmitting unit 117 of the server 1 transmits the storage location information to the information processing device 3A. In this case, the transmitting unit 117 of the server 1 may transmit predetermined data with the storage location information to the information processing device 3A or may transmit a file or an e-mail describing the storage location information to the information processing device 3A. In S707 in FIG. 7A, the receiving unit 313 of the information processing device 3A receives the storage location information from the server 1. In this case, the receiving unit 313 of the information processing device 3A may receive predetermined data with the storage location information from the server 1 or may receive a file or an e-mail describing the storage location information from the server 1.

In S708 in FIG. 7A, the determining unit 116 of the server 1 determines whether to permit or deny transmission of the storage location information in response to the request for permission to transmit the storage location information accepted from the information processing device 3A. When the determining unit 116 of the server 1 determines to deny transmission of the storage location information in response to the request for permission to transmit the storage location information accepted from the information processing device 3A, the process proceeds to S709 in FIG. 7A. In S709 in FIG. 7A, the control unit 112 of the server 1 sets an access restriction to the content data stored in the storage unit 113 or in an external storage device on the network 2. For example, an access restriction may be set in which the information processing device 3A is able to access the content data but devices other than the information processing device 3A are unable to access the content data. In addition, for example, an access restriction may be set that disables all access to the content data. Furthermore, for example, an access restriction may be set that disables all access to the content data by deleting the content data stored in the storage unit 113 or in an external storage device on the network 2. In S709 in FIG. 7A, the transmitting unit 117 of the server 1 may transmit information regarding the denial of transmission of the storage location information to the information processing device 3A. By having the receiving unit 313 of the information processing device 3A receive information regarding the denial of transmission of the storage location information from the server 1, a user of the information processing device 3A can acknowledge that the content data transmitted to the server 1 does not meet predetermined criteria.

When the determining unit 116 of the server 1 determines to permit transmission of the storage location information in response to the request for permission to transmit the storage location information accepted from the information processing device 3A, the process proceeds to S710 in FIG. 7A. In S710 in FIG. 7A, the control unit 112 of the server 1 retains an accessible state of the content data stored in the storage unit 113 or in an external storage device on the network 2.

In S711 in FIG. 7A, after a predetermined period of time has lapsed from a predetermined point in time T1, the second transmitting unit 314 of the information processing device 3A transmits the storage location information to the information processing device 3B. In this case, the second transmitting unit 314 of the information processing device 3A may transmit predetermined data with the storage location information to the information processing device 3B or may transmit a file or an e-mail describing the storage location information to the information processing device 3B. For example, the predetermined point in time T1 is a point in time when the first transmitting unit 311 of the information processing device 3A transmits the content data to the server 1, when the requesting unit 312 of the information processing device 3A makes a request to the server 1 for permission to transmit the storage location information, or when the receiving unit 313 of the information processing device 3A receives the storage location information from the server 1.

While the sequence diagram presented in FIG. 7A illustrates an example in which the second transmitting unit 314 of the information processing device 3A transmits the storage location information to the information processing device 3B, the embodiment is not limited thereto and the second transmitting unit 314 of the information processing device 3A may alternatively transmit the storage location information to the information processing device 3C. A limit may be set on the number of transmissions of the storage location information. For example, when the number of transmissions of the storage location information is set to one, once the second transmitting unit 314 of the information processing device 3A transmits the storage location information to the information processing device 3B, the second transmitting unit 314 of the information processing device 3A is no longer able to transmit the storage location information to the information processing device 3C.

In S712 in FIG. 7A, the receiving unit 321 of the information processing device 3B receives the storage location information from the information processing device 3A. In this case, the receiving unit 321 of the information processing device 3B may receive predetermined data with the storage location information from the information processing device 3A or may receive a file or an e-mail describing the storage location information from the information processing device 3A. In S713 in FIG. 7A, the displaying unit 322 of the information processing device 3B displays the storage location information. In S714 in FIG. 7A, when a user of the information processing device 3B desires to access the content data, the accessing unit 323 of the information processing device 3B accesses the content data based on the storage location information. In this case, the accessing unit 323 of the information processing device 3B may access the content data according to an instruction or an operation by the user. When the content data is retained in an accessible state in the storage unit 113 of the server 1 or in an external storage device on the network 2, the accessing unit 323 of the information processing device 3B is able to access the content data.

### Fourth Practical Example

FIG. 7B is a sequence diagram illustrating a fourth practical example of the system according to the embodiment. The sequence diagram presented in FIG. 7B illustrates an operation example of the system according to the embodiment using the server 1, the information processing device 3A, and the information processing device 3B.

In S701B in FIG. 7B, the first transmitting unit 311 of the information processing device 3A transmits content data to the server 1. In S702B in FIG. 7B, the receiving unit 111 of the server 1 receives the content data from the information processing device 3A. In S702B in FIG. 7B, the control unit 112 of the server 1 stores the content data in the storage unit 113 of the server 1 or in an external storage device on the network 2.

In S703B in FIG. 7B, the generating unit 114 of the server 1 generates storage location information indicating a storage location of the content data received from the information processing device 3A. Since processes of S704B to S712B illustrated in the sequence diagram presented in FIG. 7B are similar to the processes of S706 to S714 illustrated in the sequence diagram presented in FIG. 7A, a description of the processes of S704B to S712B illustrated in the sequence diagram presented in FIG. 7B will be omitted.

According to the third and fourth practical examples, by having the receiving unit 321 of the information processing device 3B receive the storage location information from the information processing device 3A, the accessing unit 323 of the information processing device 3B can access the content data based on the storage location information and the acquiring unit 324 of the information processing device 3B can acquire (download) the content data from the server 1. Therefore, the information processing device 3B can acquire the content data while suppressing an amount of communication between the information processing device 3A and the information processing device 3B.

According to the third practical example, by having the requesting unit 312 of the information processing device 3A make a request to the server 1 for permission to transmit the storage location information, a determination of the server 1 regarding permission or denial of transmission of the storage location information can be received and reliability of the content data at an access destination can be improved.

According to the fourth practical example, by having the first transmitting unit 311 of the information processing device 3A transmit the content data to the server 1, a determination of the server 1 regarding permission or denial of transmission of the storage location information can be received and reliability of the content data at the access destination can be improved.

When the second transmitting unit 314 of the information processing device 3A transmits the storage location information to the information processing device 3B before the lapse of a predetermined period of time from the predetermined point in time T1, the accessing unit 323 of the information processing device 3B can access the content data before a determination is made by the determining unit 116 of the server 1 to permit transmission of the storage location information. According to the third and fourth practical examples, after a predetermined period of time has lapsed from the predetermined point in time T1, the second transmitting unit 314 of the information processing device 3A transmits the storage location information to the information processing device 3B. Therefore, the accessing unit 323 of the information processing device 3B accesses the content data after a predetermined period of time has lapsed from the predetermined point in time T1. Accordingly, access to the content data before the determining unit 116 of the server 1 makes a determination to permit transmission of the storage location information can be suppressed.

According to the third and fourth practical examples, when the determining unit 116 of the server 1 determines to deny transmission of the storage location information, the control unit 112 of the server 1 sets an access restriction to the content data stored in the storage unit 113 or in an external storage device on the network 2 (refer to S708 and S709 in FIG. 7A and S7065 and S707B in FIG. 7B). Since the accessing unit 323 of the information processing device 35 accesses the content data after a predetermined period of time has lapsed from the predetermined point in time T1, access to the content data on which an access restriction is set (content data not meeting predetermined criteria) can be suppressed. For example, if an access restriction to the content data has already been set by the control unit 112 of the server 1 by the time the receiving unit 321 of the information processing device 3B receives the storage location information from the information processing device 3A, the accessing unit 323 of the information processing device 3B is unable to access the content data. On the other hand, when the determining unit 116 of the server 1 determines to permit transmission of the storage location information, the control unit 112 of the server 1 retains the content data in an accessible state. Therefore, the accessing unit 323 of the information processing device 3B is able to access the content data retained in an accessible state.

<First Modification>

In the third practical example, S711 to S714 in FIG. 7A may be modified as follows. In addition, in the fourth practical example, S709B to S712B in FIG. 7B may be modified as follows. In S711 in FIG. 7A and S709B in FIG. 7B, the second transmitting unit 314 of the information processing device 3A transmits the storage location information to the information processing device 3B before a predetermined period of time lapses from a predetermined point in time T1. In this case, the second transmitting unit 314 of the information processing device 3A may transmit predetermined data with the storage location information to the information processing device 3B or may transmit a file or an e-mail describing the storage location information to the information processing device 3B. In S712 in FIG. 7A and S710B in FIG. 7B, the receiving unit 321 of the information processing device 3B receives the storage location information from the information processing device 3A. In this case, the receiving unit 321 of the information processing device 3B may receive predetermined data with the storage location information from the information processing device 3A or may receive a file or an e-mail describing the storage location information from the information processing device 3A.

Next, in S713 in FIG. 7A and S711B in FIG. 7B, the displaying unit 322 of the information processing device 3B displays the storage location information. In S714 in FIG. 7A and in S712B in FIG. 7B, when a user of the information processing device 3B desires to access the content data, the accessing unit 323 of the information processing device 3B stands by until a predetermined period of time lapses from the predetermined point in time T1, and accesses the content data based on the storage location information after the predetermined period of time has lapsed from the predetermined point in time T1. In this case, the accessing unit 323 of the information processing device 3B may access the content data according to an instruction or an operation by the user. Until the predetermined period of time lapses from the predetermined point in time T1, the displaying unit 322 of the information processing device 3B may display a message to the effect that the content data is not accessible until a predetermined time.

According to the first modification, the accessing unit 323 of the information processing device 3B stands by until a predetermined period of time lapses from the predetermined point in time T1, and accesses the content data after the predetermined period of time has lapsed from the predetermined point in time T1. Accordingly, access to the content data before the determining unit 116 of the server 1 makes a determination to permit transmission of the storage location information can be suppressed.

<Second Modification>

In the third practical example, S711 to S713 in FIG. 7A may be modified as follows. In addition, in the fourth practical example, S709B to S711B in FIG. 7B may be modified as follows. In S711 in FIG. 7A and S709B in FIG. 7B, the second transmitting unit 314 of the information processing device 3A transmits the storage location information to the information processing device 3B. In this case, the second transmitting unit 314 of the information processing device 3A may transmit predetermined data with the storage location information to the information processing device 3B or may transmit a file or an e-mail describing the storage location information to the information processing device 3B. In 5712 in FIG. 7A and S710B in FIG. 7B, the receiving unit 321 of the information processing device 3B receives the storage location information from the information processing device 3A. In this case, the receiving unit 321 of the information processing device 3B may receive predetermined data with the storage location information from the information processing device 3A or may receive a file or an e-mail describing the storage location information from the information processing device 3A.

Next, in S713 in FIG. 7A and S711B in FIG. 7B, the displaying unit 322 of the information processing device 3B displays the storage location information after a predetermined period of time has lapsed from a predetermined point in time T2. For example, the predetermined point in time 12 is a point in time when the first transmitting unit 311 of the information processing device 3A transmits the content data to the server 1, when the requesting unit 312 of the information processing device 3A makes a request to the server 1 for permission to transmit the storage location information, when the receiving unit 313 of the information processing device 3A receives the storage location information from the server 1, or when the receiving unit 321 of the information processing device 3B receives the storage location information from the information processing device 3A. The receiving unit 321 of the information processing device 3B may receive information regarding the predetermined point in time 12 from the information processing device 3A.

In the second modification, the displaying unit 322 of the information processing device 3B displays the storage location information after a predetermined period of time has lapsed from the predetermined point in time 12. Therefore, the accessing unit 323 of the information processing device 3B accesses the content data after a predetermined period of time has lapsed from the predetermined point in time 12. Accordingly, access to the content data before the determining unit 116 of the server 1 makes a determination to permit transmission of the storage location information can be suppressed.

<Third Modification>

In the third practical example, S711 to S713 in FIG. 7A may be modified as follows. In addition, in the fourth practical example, S709B to S711B in FIG. 7B may be modified as follows. In S711 in FIG. 7A and S709B in FIG. 7B, the second transmitting unit 314 of the information processing device 3A transmits the storage location information to the information processing device 3B. In this case, the second transmitting unit 314 of the information processing device 3A may transmit predetermined data with the storage location information to the information processing device 3B or may transmit a file or an e-mail describing the storage location information to the information processing device 3B. In S712 in FIG. 7A and S710B in FIG. 7B, the receiving unit 321 of the information processing device 3B receives the storage location information from the information processing device 3A. In this case, the receiving unit 321 of the information processing device 3B may receive predetermined data with the storage location information from the information processing device 3A or may receive a file or an e-mail describing the storage location information from the information processing device 3A.

Next, in S713 in FIG. 7A and in S711B in FIG. 7B, when the accessing unit 323 of the information processing device 3B accesses the server 1 and confirms that permission to transmit the storage location information has been determined, the displaying unit 322 of the information processing device 3B displays the storage location information. On the other hand, in S713 in FIG. 7A and in S711B in FIG. 7B, when the accessing unit 323 of the information processing device 3B accesses the server 1 and confirms that denial to transmit the storage location information has been determined, the displaying unit 322 of the information processing device 3B does not display the storage location information. In this case, the accessing unit 323 of the information processing device 3B verifies that permission or denial to transmit the storage location information has been determined by accessing the server 1 at predetermined intervals. If a determination to permit or deny transmission of the storage location information has not been made by the time when the accessing unit 323 of the information processing device 3B accesses the server 1, the displaying unit 322 of the information processing device 3B may display a message to the effect that a determination to permit or deny transmission of the storage location information has not been made.

In the third modification, when permission to transmit the storage location information has been determined, the displaying unit 322 of the information processing device 3B displays the storage location information. Therefore, when permission to transmit the storage location information has been determined, the accessing unit 323 of the information processing device 3B accesses the content data. Accordingly, access to the content data before the determining unit 116 of the server 1 makes a determination to permit transmission of the storage location information can be prevented.

<Fourth Modification>

In the third practical example, S711 in FIG. 7A may be modified as follows. In addition, in the fourth practical example, S709B in FIG. 7B may be modified as follows. In S711 in FIG. 7A and in S709B in FIG. 7B, when the accessing unit 316 of the information processing device 3A accesses the server 1 and confirms that permission to transmit the storage location information has been determined, the second transmitting unit 314 of the information processing device 3A transmits the storage location information to the information processing device 3B. In this case, the second transmitting unit 314 of the information processing device 3A may transmit predetermined data with the storage location information to the information processing device 3B or may transmit a file or an e-mail describing the storage location information to the information processing device 3B. On the other hand, in S711 in FIG. 7A and in S709B in FIG. 7B, when the accessing unit 316 of the information processing device 3A accesses the server 1 and confirms that denial to transmit the storage location information has been determined, the second transmitting unit 314 of the information processing device 3A does not transmit the storage location information to the information processing device 3B. In this case, the accessing unit 316 of the information processing device 3A verifies that permission or denial to transmit the storage location information has been determined by accessing the server 1 at predetermined intervals.

In the fourth modification, when permission to transmit the storage location information has been determined, the second transmitting unit 314 of the information processing device 3A transmits the storage location information to the information processing device 3B. Therefore, when permission to transmit the storage location information has been determined, the receiving unit 321 of the information processing device 3B receives the storage location information and the accessing unit 323 of the information processing device 3B accesses the content data. Accordingly, access to the content data before the determining unit 116 of the server 1 makes a determination to permit transmission of the storage location information can be prevented.

It is possible to record a program which causes a computer to implement any of the functions described above on a computer readable recording medium. By causing the computer to read in the program from the recording medium and execute it, the function thereof can be provided. The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims. While the embodiment has been described above in detail, the above description merely exemplifies the embodiment in all aspects and is not intended to limit the scope of the embodiment. It is needless to say that various changes and modifications may be made in the embodiment without departing from the scope thereof. It will also be understood by those skilled in the art that an equivalent scope of the embodiment can be implemented using technical common sense on the basis of the specific description of the embodiment. Furthermore, it is understood that, unless otherwise specified, terms used in the present specification are used in the meanings usually used in the art. Therefore, unless otherwise defined, all technical and scientific terms used in the present specification have the same meaning as commonly understood by one of ordinary skill in the art to which this embodiment belongs. In case of conflict, the present specification (including definitions) will control.

What is claimed is:

1. A non-transitory computer readable medium recorded with an information processing program executed by a computer of an information processing device, the information processing program causing the computer to function as:
a first transmitting unit to transmit content data to a server that determines whether to permit or deny transmission of storage location information indicating a storage location of the content data;
a receiving unit to receive the storage location information from the server; and
a second transmitting unit to transmit the storage location information to another information processing device.

2. The non-transitory computer readable medium recorded with the information processing program according to claim 1, wherein the information processing program further causes the computer to function as:
a requesting unit to request the server for permission to transmit the storage location information.

3. The non-transitory computer readable medium recorded with the information processing program according to claim 1, wherein the server determines whether to permit or deny transmission of the storage location information when the content data is received from the information processing device.

4. The non-transitory computer readable medium recorded with the information processing program according to claim 1, wherein
the receiving unit receives the storage location information transmitted by the server after the server determines to permit transmission of the storage location information, or
when the other information processing device accesses the server and verifies that a determination has been made to permit transmission of the storage location information, the storage location information is displayed on a displaying unit included in the other information processing device.

5. The non-transitory computer readable medium recorded with the information processing program according to claim 1, wherein the receiving unit receives the storage location information transmitted by the server after the server determines to permit transmission of the storage location information.

6. The non-transitory computer readable medium recorded with the information processing program according to claim 1, wherein when the other information processing device accesses the server and verifies that a determination has been made to permit transmission of the storage location information, the storage location information is displayed on a displaying unit included in the other information processing device.

7. The non-transitory computer readable medium recorded with the information processing program according to claim 1, wherein the second transmitting unit transmits the storage location information to the other information processing device after the server determines to permit transmission of the storage location information.

8. The non-transitory computer readable medium recorded with the information processing program according to claim 1, wherein when the content data meets predetermined criteria, the server determines to permit transmission of the storage location information.

9. The non-transitory computer readable medium recorded with the information processing program according to claim 1, wherein the information processing program further causes the computer to function as:
a detecting unit to detect the other information processing device, and
the second transmitting unit transmits the storage location information to the other information processing device that is detected by the detecting unit.

10. The non-transitory computer readable medium recorded with the information processing program according to claim 9, wherein
the detecting unit comprises:
a beacon transmitting unit to transmit a beacon; and
a response receiving unit to receive a response to the transmitted beacon from the other information processing device, and
the second transmitting unit transmits the storage location information to the other information processing device that has transmitted the response received by the response receiving unit.

11. The non-transitory computer readable medium recorded with the information processing program according to claim 1, wherein the second transmitting unit transmits the storage location information to the other information processing device after a predetermined period of time has lapsed from a predetermined point in time.

12. The non-transitory computer readable medium recorded with the information processing program according to claim 1, wherein the storage location information received by the other information processing device is displayed on a displaying unit included in the other information processing device after a predetermined period of time has lapsed from a predetermined point in time.

13. The non-transitory computer readable medium recorded with the information processing program according to claim 11, wherein the predetermined point in time is a point in time when any one of the first transmitting unit, the requesting unit, and the receiving unit is executed.

14. The non-transitory computer readable medium recorded with the information processing program according to claim 1, wherein the number of executions of the second transmitting unit is limited.

15. The non-transitory computer readable medium recorded with the information processing program according to claim 1, wherein the content data is UGC (User Generated Content) data.

16. The non-transitory computer readable medium recorded with the information processing program according to claim 1, wherein the storage location information is a URL (Uniform Resource Locator).

17. An information processing device comprising:
a first transmitting unit to transmit content data to a server that determines whether to permit or deny transmission of storage location information indicating a storage location of the content data;
a receiving unit to receive the storage location information from the server; and
a second transmitting unit to transmit the storage location information to the other information processing device.

18. An information processing system comprising: a server that determines whether to permit or deny transmission of storage location information indicating a storage location of content data; a first information processing device; and a second information processing device, wherein
the first information processing device includes:
a first transmitting unit to transmit the content data to the server;
a receiving unit to receive the storage location information from the server; and
a second transmitting unit to transmit the storage location information to the second information processing device.

19. An information processing method executed by a computer of an information processing device, the method comprising:
transmitting content data to a server that determines whether to permit or deny transmission of storage location information indicating a storage location of the content data;
receiving the storage location information from the server; and
transmitting the storage location information to another information processing device.
